(19) United States
(12) Patent Application Publication
(10) Pub. No.: US 2019/0318609 A1
(43) Pub. Date: Oct. 17, 2019

(54) VEHICLE EMERGENCY ALERT SYSTEM (VEMAS)

(71) Applicants: Stella Efe Obayuwana, Bowie, MD (US); Jason Osaseniga Matthews, Bowie, MD (US)

(72) Inventors: Stella Efe Obayuwana, Bowie, MD (US); Jason Osaseniga Matthews, Bowie, MD (US)

(21) Appl. No.: 16/213,984

(22) Filed: Dec. 7, 2018

Related U.S. Application Data
(60) Provisional application No. 62/596,816, filed on Dec. 9, 2017.

(51) Int. Cl. G08B 25/01; B60R 25/102; B60Q 1/52; B60Q 5/00

(52) U.S. Cl. CPC G08B 25/016; B60Q 5/005; B60Q 1/52; B60R 25/102

(57) ABSTRACT

A vehicle emergency system, which alerts drivers, passersby, and emergency responders of vehicle and personal emergencies, in occasions that occupant(s) of vehicle(s) is(are) unable to personally request help or notify others, of actual or impending emergencies. Upon activation, the system selects a pre-programmed alert message(s), which is/are conspicuously displayed or relayed, through appropriate media, based on the alert-type selected. The system also can disable a vehicle under certain circumstances. Alert messages are programmed to communicate personal, such as medical emergencies; vehicle-related emergencies, like flat tires or brake problems, as well as requesting assistance. VEMAS prevents accidents and injuries in situations where the driver is unable to properly control the vehicle, by alerting other drivers to steer clear of the vehicle having the emergency. It provides faster medical response, such as CPR, since other drivers, passengers or passersby may be doctors, nurses or other medical professionals who may be able to respond faster than an ambulance or the police. When properly utilized, this system will serve as a safety and security system, which may provide beneficial solutions in life or death situations.

### BACKGROUND OF THE INVENTION

This invention is in the field of security, safety, and medical emergency alert notification and communication system for vehicles and other non-vehicular entities.

Emergency can occur anytime and to anyone, places or things, including a vehicle, its driver, and the environment in which the vehicle is operated. Therefore, there is a need for an alert system which aids drivers and vehicle occupants in providing notification of actual and/or impending emergencies to other drivers, passersby, and emergency responders, in the event that they are incapacitated, unable to personally provide/request the required emergency assistance, and unable to personally, communicate the emergency and/or need for assistance to others.

The need for VEMAS was born out of personal experiences. When my son was two years old, he travelled with me daily, about an hour drive to his daycare, close to my job. One day, amid Washington, D.C. traffic he began to choke on his snack. Driving and unable to pull over, all I could do was pray, as my attempt to pull to the side of the road, only served to make other drivers speed up and ensured I didn't get in front of them. Had I been able to pull over, I still would have needed immediate assistance, since I was not conversant with providing CPR to children. Thankfully, the choking was minor, and it passed. Nonetheless, I could not help but think about the possibility of a worst-case scenario and the helplessness I felt not being able to communicate my emergency to the hundreds of passersby. So, I thought about VEMAS, a system that can safely communicate emergencies without you stopping in the middle of the road and waving a “help me” flag.

A second experience occurred after I was diagnosed with a muscle-limiting condition. On a certain day, I was driving, and I began to feel my muscles weaken and my eyelids drooping. But there was no way of alerting other drivers and passersby of my situation, again, all I could do was pray and clench my steering wheel with the remainder of my failing muscle strength. I felt helpless and again, had to look to God for inner strength, as always, He came through for me. Additionally, he reminded me of VEMAS.

Frequently, we see tires from moving vehicles blown to pieces, engines giving up the ghost in the middle of the road, even during fast moving traffic, and in most cases, we see drivers standing helplessly by their vehicles unable to effectively communicate their emergencies. In some situations, cellular phone batteries may die on us and cannot be charged because the vehicle also quitted on us, or we may not have our cellphones handy, sometimes the light bulbs are out, and we cannot use the “blinking lights”. Without a system like VEMAS, it will be difficult to ask and receive the immediate assistance we all need at times like these. Some of these situations may be life or death situations where vehicle operators or their passengers need instant emergency assistance. Thankfully, there is VEMAS “The Rescuer.”

U.S. Patent Application 20150261769 (Ono, Joanne Uta, et al.) discloses “a system, devices and methods for initiating and executing a response to an event, an adverse event. Embodiments of the invention allow a user to use a mobile electronic communication device, such as a smart phone, to access communication channels to generate a list of contactable entities relevant to the event, prioritized by considerations like proximity, appropriateness for the type of event, and appropriateness for the risk level of the event. Additionally, embodiments of the invention may allow for aspects of the management of a response to the event, for instance by enabling a network of responders, created based on the prioritized list of contactable entities.”

Ono does not disclose displaying emergency messages and alerts on the body of vehicles or on devices attached to vehicles, nor systems that solicit passersby to provide or request assistance, directly or remotely, on behalf of the person or vehicle experiencing the event. Ono also does not disclose a vehicle's built-in or detachable system(s), aside of mobile electronic communication devices like smart phones, which can be manually or remotely operated to provide pre-programmed emergency messages or alerts. Further, Ono does not disclose a functionality that uses cellular (or smart) phones to notify others of an emergency such that they can request assistance on behalf of the person/vehicle involved in the event.

US Patent Application 20130222133 (Schultz, P T, et al.) discloses an approach for enabling event notifications to be directed to one or more contacts based on the acquiring of common event data by one or more wireless devices. A multimedia event processor receives event data corresponding to an event from a mobile device. The event data is associated with a tag for describing the event data and classified as corresponding to a level of severity based on the tag. A target destination is then determined for transmission of a notification message, the event data, or a combination thereof. Parties to be notified are selected from a user-designated group. Severity is represented by a tag, wherein the tag is associated with the event based on a match between the observed event and a predetermined type of event selected from a group of predetermined types of events.

Schultz does not disclose displaying emergency messages and alerts on the body of vehicles or on devices attached to vehicles, nor systems that solicit passersby to provide or request assistance, directly or remotely, on behalf of the person or vehicle experiencing the event.

US Patent Application 20130052982 (Rohde, G L, et al.) discloses a mobile application for execution on a handheld computing device, that stores data regarding connections to public safety answering points, with which to share information in an emergency situation and establishes connections with an appropriate public safety answering point upon activation of an emergency button. Wherein, the connections include voice, text, image and video connections. A user can create a list of contacts for a private social emergency response network with which to send previously stored private information in an emergency. In an emergency, the mobile application establishes a platform via which the user and those on the private social emergency response network can share information. The mobile application also sends previously stored private information to those on the list during an emergency.

Rohde does not disclose a capability to search local communication channels for contact entities in case of an event, where the entities may not be known to a user of the device, or have not been entered previously by the user into the device, such as passersby responding to the user's vehicle emergency display. Rohde also does not disclose devices which displays emergency messages and alerts on the body of vehicles or on devices attached to vehicles, nor systems that solicit passersby to provide or request assistance, directly or remotely, on behalf of the person or vehicle experiencing the event.

U.S. Pat. No. 8,493,208 (Aaron, J.) discloses a wireless communication device and a communication device control method that includes a set of templates corresponding to a plurality of potential environmental circumstances. The templates may be stored in a database in the computer readable memory of the communication device. At predetermined intervals, a suite of environmental sensors integral to the communication device may periodically sample the user's environment. The user's environmental circumstances may be derived or inferred by an analysis module based on the output of the suite of environmental sensors and then may be compared to the templates to determine a matching template. An action script is then executed based at least partially on the matching template, which may include the contacting of a responding party.

Aaron does not disclose vehicle emergency alert and notification system, which can be manually or remotely operated to notify and contact pre-programmed entities in case of an personal and vehicle emergency event or in situations not specifically environmental in nature. Aaron also does not disclose devices which displays emergency messages and alerts on the body of vehicles or on devices attached to vehicles, nor systems that solicit passersby to provide or request assistance, directly or remotely, on behalf of the person or vehicle experiencing the event.

U.S. Pat. No. 8,630,820 (Amis, D.) discloses methods and systems anticipating a potentially threatening or dangerous incident and providing varying levels of response to a user. In an exemplary embodiment, the present invention provides varying levels of assistance to a user prior to, during, and after a threatening incident occurs. By providing assistance prior to a threatening incident occurring, the system may be able to thwart potential attacks, bodily harm, robberies, break-ins, and other criminal or dangerous activity. The assistance can be, for example, in the form of deterrents, alerting first responders to go to the scene, sending security personnel to the scene, remotely monitoring the scene, remotely interacting with the scene, providing information and advice to the user.

Amis does not disclose vehicle emergency alert and notification system, which can be manually or remotely operated to notify and contact pre-programmed entities in case of a vehicle emergency event. Amis also does not disclose devices which displays emergency messages and alerts on the body of vehicles or on devices attached to vehicles, nor systems that solicit passersby to provide or request assistance, directly or remotely, on behalf of the person or vehicle experiencing the event.

US Patent Application 20100158202 (Johnson, R S. Et al.) discloses a method for dispatching emergency responders. The method identifies emergency responders proximate an emergency incident site. Of these emergency responders, qualified emergency responders are identified, wherein qualified emergency responders have sufficient resources to service an emergency incident at the emergency incident site. The method identifies travel obstructions between the qualified emergency responders and the emergency incident site. Travel times between each of the qualified emergency responders and the emergency incident site are determined based on the travel obstructions. A first emergency responder is selected from the qualified emergency responders, wherein the first emergency responder has a first travel time that is the shortest travel time of the determined travel times. One or more standby emergency responders are also selected, wherein the standby emergency responders have a second travel time that is the next shortest travel time of the determined travel times.

Johnson does not include entities within immediate vicinity of the vehicle and users, aside of emergency responders requiring travel, which do not need to travel from alternate locations to the incident site, such as a nurse, doctor, or other passersby, responding to the user's displayed alert notification, or electronic, or alarmed notification of emergency. Johnson does not disclose a capability of changing the priority based on real time assessments of developments in the location of the event or utilizing pre-programmed messages to signal for help.

None of the preceding innovations, and other inventions like OnStar, exclusively utilizes a pre-programmed system to display pre-programmed alerts and messages immediately visible within and outside of the vehicle, to communicate impending and actual emergencies to passersby, emergency responders, and other pre-programmed recipients, based on real-time events. None of the preceding innovations provide for systems that solicit passersby to provide or request assistance, directly or remotely, on behalf of the person or vehicle experiencing the event. None of the aforementioned innovations discloses a vehicle's built in or detachable system(s), aside of mobile electronic communication devices like smart phones, which can be manually or remotely operated to provide pre-programmed emergency messages or alerts. Further, the aforementioned innovations do not disclose a functionality that uses cellular (or smart) phones to automatically notify others of an emergency or impending emergency and requiring them to request for responders/assistance on behalf of the person/vehicle involved in the event

Therefore, it is imperative to invent an alert system to provide a means for communicating emergencies within the immediate vicinity of the event. A system that is crucial in a life or death situation where immediate response is required. It is imperative to provide a system that can be activated remotely or manually by the user to display pre-programmed messages and alerts on a vehicle. A system with the capability to send pre-programmed messages to pre-programmed recipients, disable vehicles after a specified time lag, to guarantee the safety of the operator, in the event of theft, to sound alarms when so actuated/activated and prevent accidents by signaling impending and actual personal, vehicular, and environmental emergencies to others within the vicinity. For law enforcement personnel, this system may be used to communicate when their usual communication devices fail. Insurance, auto manufacturers, warranty companies, and medical entities as well as other entities not specifically mentioned, may also benefit from this invention.

Vehicle operators and their passengers need a means of communication without the dangers on winding down a window and screaming for help, waving by the side of the road, stopping abruptly in fast moving traffic, and helplessly suffering medical emergencies without a fast means of communication and without immediate life-saving response. They need a system to communicate quickly in an emergency or impending emergency: VEMAS is that system.

### SUMMARY

VEMAS is a vehicle emergency system, which alerts drivers, passersby, preselected recipients, and emergency responders, of vehicle and personal emergencies, in the event that the occupant(s) of a vehicle is (are) unable to personally request help or notify others, of actual or impending emergencies. When activated, the system selects pre-programmed alert messages which are conspicuously displayed, relayed, or sounded in the appropriate media, based on the alert-mode activated. Alert messages can be in the form of readable lighting, audible sounds, electronic messaging, or in combinations. The system also can disable a vehicle under certain circumstances, such as situations where a car is hijacked, or during highway robberies, drivers will have the option of pressing a delayed display button and/or a remote-controlled button or devices that can self-actuate/self-activate after a specified time has elapsed to shut down the vehicle. This delay button can only be switched off with pre-programmed passcodes. The time lapse is for safety and security of the operator, to ensure he/she is away from the harmful situation or has help before the vehicle is disabled.

Applicability of this system encompass several emergency, safety and security situations to include, but not limited to, medical emergencies (e.g. stroke, heart attacks, choking, epileptic seizures, etc.), hostile emergencies (robberies, carjacking, etc.), vehicular emergencies (inoperability, mechanical failures, blown tires, etc.), fires (through fire sensor), flooding (through flood sensor), and more. For instance, a driver having a heart attack and unable to personally request help or notify others, may only be able to push a button (digital or manual) or by depressing a foot pedal in his vehicle, is able to activate a lighting system, such as LED or strobe lights, to display messages on the outside or inside (including windshield) of the vehicle so others can see that he needs help.

Alarm option, telephone system, etc. may also be used to serve the same alert purpose as describe above, in place of Led lights. Cellular phone apps system may also automatically send text messages or email to pre-designated persons, to notify them of the emergency. VEMAS can be applied in several other situations, like police stops, for the police to call for backup in situations where their radio or communication systems are inoperable or slow. VEMAS and its cellular phone app can be used to track missing devices, vehicles, animals, or missing/lost persons, through the tracking app.

### REFERENCE NUMERALS IN DRAWINGS

### Reference Components

1-1 Steering wheel with VEMAS Pushbutton
1-2 Radio/Stereo/GPS or similar system
1-3 Side of the console
1-4 Glove compartment
1-5 Possible location for VEMAS system
1-6 Part of the dashboard
4-1 Compressible/flexible material
4-2 Neo Magnet for mounts
4-3 Visual/Banner Display
5-1 Mount
5-2 Neo Magnet
5-3 PVC Display Unit
8-1 Swivel
8-2 Suction Cup
8-3 Banner Display Panel (BDP)
13-1 Possible VEMAS (Input) components
13-2 Possible VEMAS (Core) components
13-3 Possible VEMAS (Output) components
“V” VEMAS Icons
“911” Panic button

### REFERENCE FIGURES

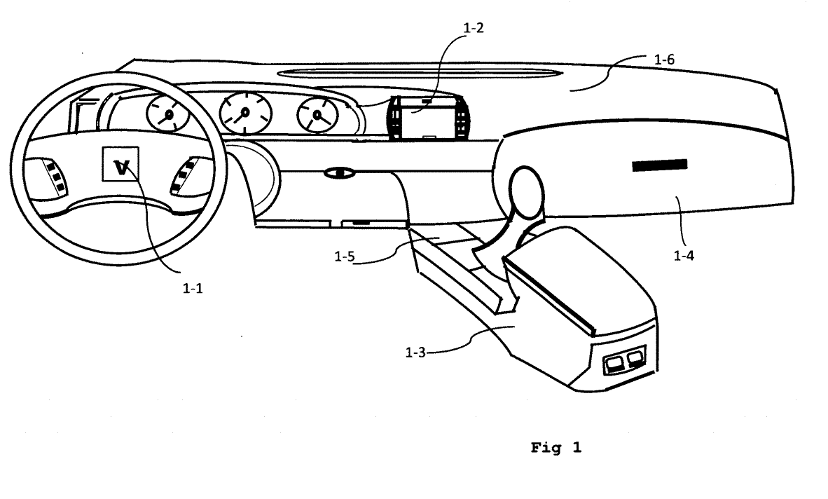

FIG. 1 Front-Interior of vehicle

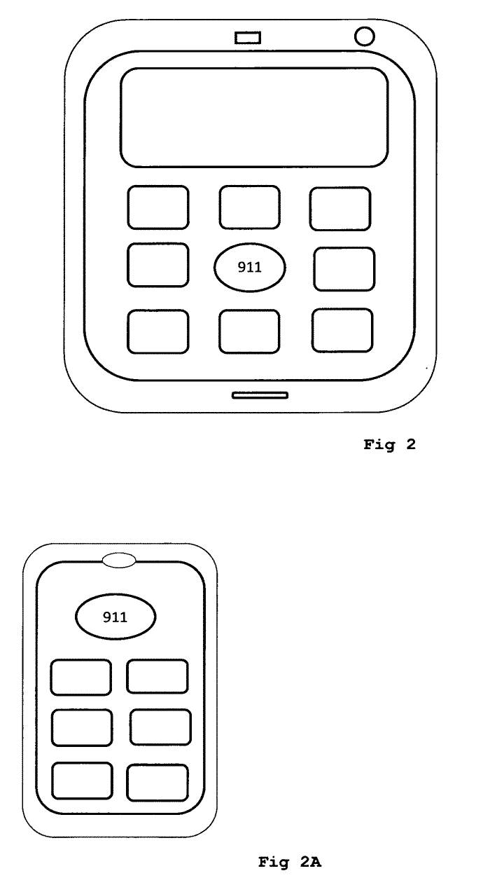

FIG. 2 Stand-alone VEMAS system

FIG. 2A Remote control

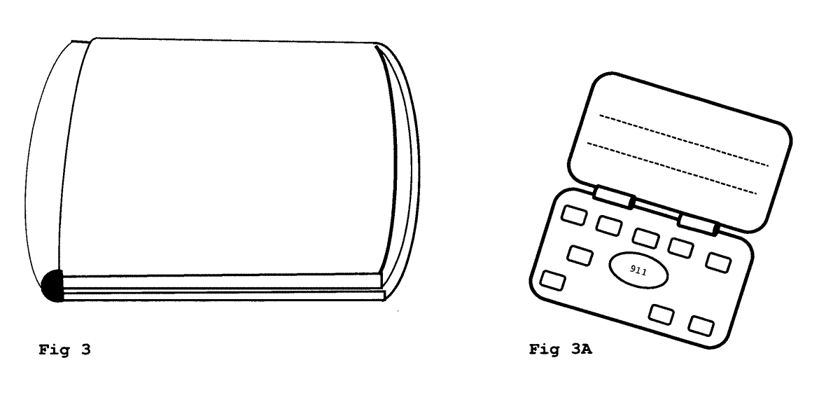

FIG. 3 Stand-alone VEMAS Unit

FIG. 3A Inside markings of Stand-Alone VEMAS Unit

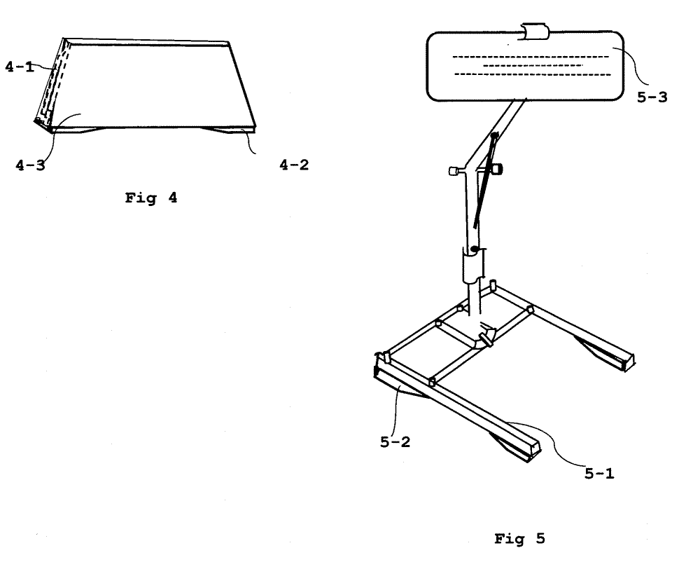

FIG. 4 Visual/Banner Display System

FIG. 5 PVC (Retractable) VEMAS Display System

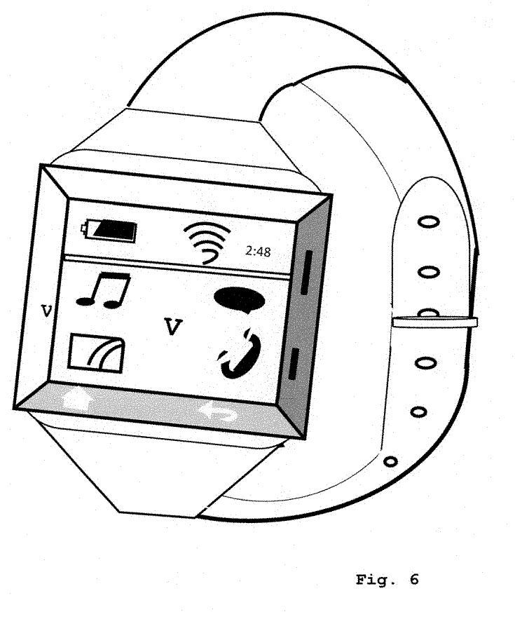

FIG. 6 Smart watch

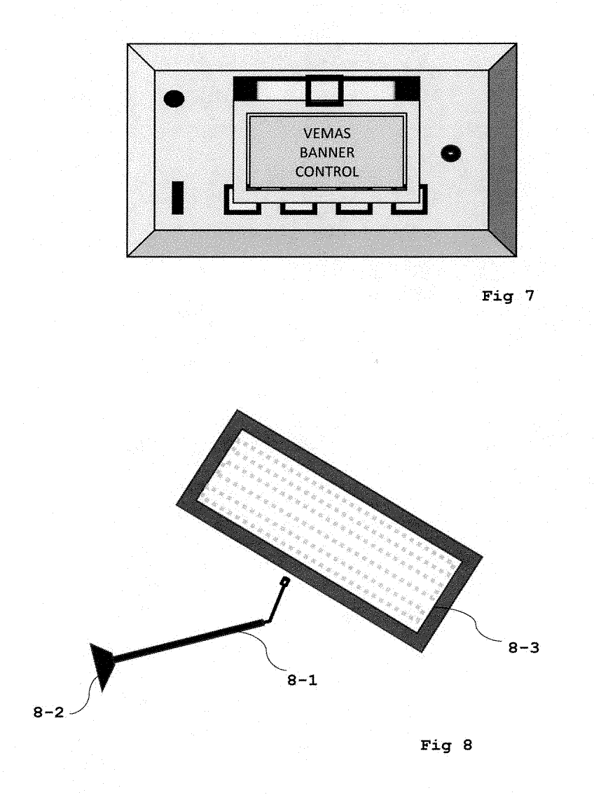

FIG. 7 LED Banner Control unit

FIG. 8 LED Banner Display System

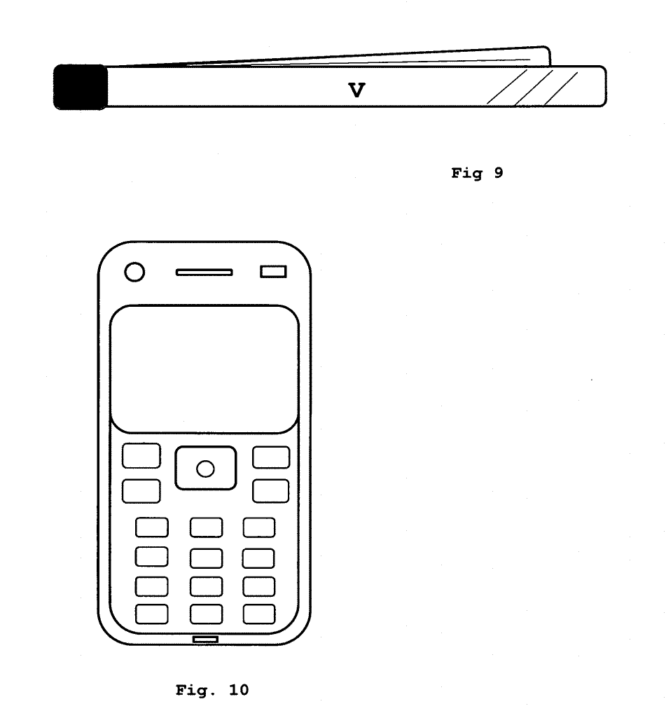

FIG. 9 Tie clip with a VEMAS (V) activating push button

FIG. 10 Phone with a VEMAS (V) activating push button.

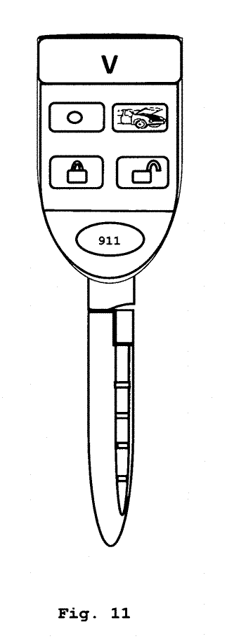

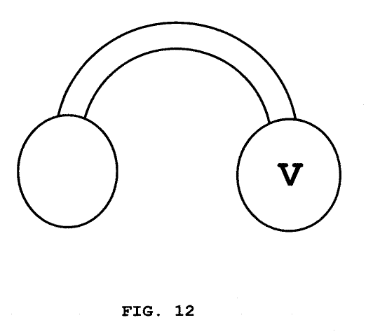

FIG. 11 Vehicle Entry key with a VEMAS Icon

FIG. 12 Headphone with a VEMAS activating push button.

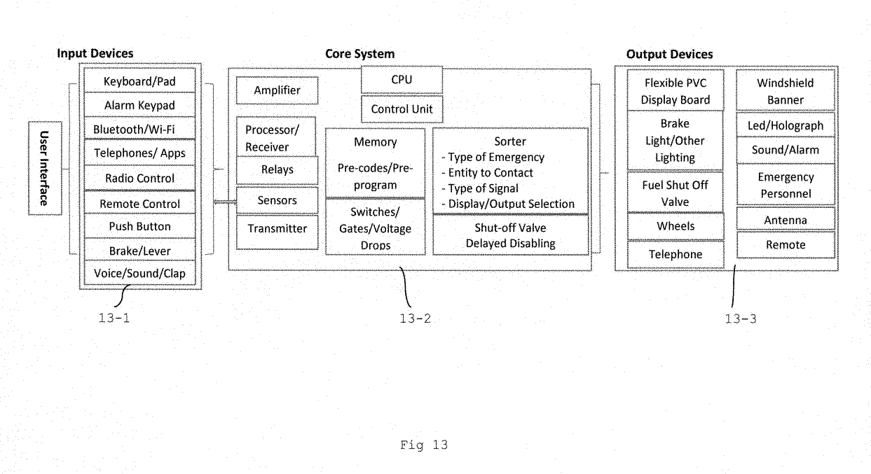

FIG. 13 Input-Core-Output Diagram

### BRIEF DESCRIPTION OF THE DRAWINGS

In the following examples of preferred embodiments, the detailed portion of the description and application of the system, sample drawings will be referenced.

### BRIEF DESCRIPTION OF DRAWINGS FIGURES

FIG. 1 Vehicle's Interior (Front): Depicts components 1-1-1-6, which represent possible locations of VEMAS Pushbuttons, keyboards, stand-alone units, etc.

FIG. 2 Stand-alone VEMAS System (portable/detachable). Could be installed in FIG. 1 Components, like 1-5.

FIG. 2A Remote control with VEMAS capabilities and Application.

FIG. 3 Stand-alone VEMAS unit (for internal/external use) It should be waterproofed when used externally. Could be mounted on the vehicle's roof. It may be detachable.

FIG. 3A Inside markings and design of VEMAS stand-alone unit (FIG. 3). There's design flexibility for VEMAS systems.

FIG. 4 Visual/Banner Display System (V/BDS). Comprise flexible/compressible material, 4-1 and magnet mounts, 4-2, and visual/banner display unit, 4-3. It could be retractable.

FIG. 5 PVC Display System. Comprise a mount component 5-1, Neo-magnet 5-2, and (Retractable/flexible or rigid) PVC Display unit, 5-3.

FIG. 6 Smart watch with VEMAS push button (V)/function. It can be used similarly as a cellphone. The VEMAS pushbutton on the watch activates/disseminates disseminates the alert/emergency message.

FIG. 7 LED Banner Control Unit (LBCU). It controls the LBDD/U

FIG. 8 LED Banner Display System (LBDS). It Comprise swivel component, 8-1, suction cup mount, 8-2 and Banner Display Panel (BDP) that displays LED messages, 8-3.

FIG. 9 Tie clip with a VEMAS activating push button FIG. 10 Cellular Phone with a VEMAS activating push button. Cellphones can be used as an Input/output device.

FIG. 11 Vehicle Entry Key with VEMAS activating push button FIG. 12 Headphone with VEMAS activating push button.

FIG. 13 Depicts possible Input/Core/Output components diagram.

### BRIEF DESCRIPTION OF DRAWINGS/FIGURES COMPONENTS

FIG. 1 Components:

VEMAS' input devices and core systems, etc., can be installed on/in the vehicle's components below:
1-1 Steering Wheel.
1-2 Radio/Stereo/GPS or similar system
1-3 Console (Side)
1-4 Glove Compartment
1-5 Console
1-6 Dashboard Part of the dashboard

FIG. 4 Components:
4-1 Compressible/collapsible/flexible/material—to flatten V/BDP, 4-3.
4-2 (Neo) Magnet. This is a magnet mount option to hold the display unit, such as FIG. 4, in place.
4.3 Visual/Banner Display Panel—displays LED message.

FIG. 5 Components:
5-1 Mount for VEMAS system and output devices.
5-2 Neo-magnet mounts to hold the mount (5-1) in place.
5-3 Polyvinyl Chloride (PVC) Display Unit. It could be flexible or rigid.

FIG. 8 Components:
8-1 Swivel. Used for rotation and positioning.
8-2 Suction Cup. Used as mount.
8-3 Banner Display Panel (BDP)—displays LED messages.

FIG. 13 Components:
13-1 Possible VEMAS (Input) components
13-2 Possible VEMAS (Core) components
13-3 Possible VEMAS (Output) components

Other Referenced Components:
Letter V: “V” letter or “V” Icon, show locations/possible location of VEMAS systems, pushbuttons or activation mechanism.
“911”: Panic button, it dials 911 or other designated entities.
   These figures and components are not all encompassing or limiting, there is flexibility in designing VEMAS System(s)

### Preferred Embodiment

A preferred embodiment of the system may utilize certain systems, already existing in the vehicle, as well as components of the invention. Existing systems include vehicle dashboard, steering wheel and steering column, windshield, certain electrical and electronic components of the vehicle, brake, lights, power sources, horn, glove compartment, console, pedals, radios, mounted telephones (installed/prepaid), etc.

### Preferred Embodiments—Input Devices

Input devices can be, but not limited to, push buttons, with possible locations shown in FIG. 1 and its components, 1-1, 1-2, 1-3, 1-4, 1-5, and 1-6 and keyboards or keypads as shown in FIG. 2, FIG. 2A, and FIG. 3A. Levers; pedals; telephones (installed/prepaid); telephones (cellular/mobile/wireless) FIG. 10; remote entry key, FIG. 11; remote controls, FIG. 2A; alarm keypads and other vehicle alarm devices, radio control, component 1-2, etc. Input devices provide “user's interfaces” where the user is able to select pre-programmed alert/messages applicable to their emergency and the desired alert/output.

In one embodiment, the input device may be a keyboard or mini-keyboard ensemble, FIGS. 2 and 2A, with pre-coded letters, numbers or words, to enable the user to select their desired input and alert type. This keyboard device may also house the core systems and possible core components like 13-2.

The input device may either be hardwired or standalone devices like, FIG. 2, 2A, 3 and FIG. 3A, or hardwired to existing vehicle systems, like steering wheel, radios, GPS, brake, sound, alarm, lighting systems or electrical/electronic systems, etc. FIGS. 2, 2A and FIGS. 3 and 3A can also be portable/detachable. Other portable device which can be hand carried or worn include smart watch, FIG. 6, necktie clip with VEMAS (Letter “V”) pushbutton, FIG. 9, headphones, FIG. 12, and such devices, can be used in this embodiment.

In a second embodiment, input devices could be part of, or combined with the core system depicted in FIGS. 2, 2A, 3, 3A and 5, and mounted on certain surfaces of the vehicle, such as the windshield, roof and dashboard FIG. 1-6. Magnet components, 4-2 and 5-2, can be used to mount these devices to the surfaces. The user selects from the preprogrammed input which triggers the core system to select an appropriate alert/response type to be processed and transmitted to the output system and displayed based on the alert type and display medium triggered by the user's input. This embodiment will be a one-piece input-core-output system.

In a third embodiment, the input device may be push buttons/pad such as indicated with letter “V” on the steering wheel component, 1-1, or levers, pedals, with similar operation and functionality as that of the keyboard embodiments of FIGS. 2, 2A, 3 and 3A.

In a fourth embodiment, the input may be voice activation, hand clap and wireless or remote input. Whereby by the sound of the user's voice, clap of the hand or remote activation of the emergency, the input device activates and triggers the core system to transmit the desired message and response/output type to the output system. Wireless/Wi-Fi and Bluetooth technology may be used in this embodiment.

Core System (Processor): Core systems, FIGS. 2, 2A, 3, 3A, 5, 7 and component 13-2, may include, but not limited to, electrical, electronic and telecommunication systems, lighting systems, mechanical systems, holographic, systems, computer applications, telephone applications, navigation systems, Wi-Fi/Bluetooth systems or devices, shut-off valves and shut-off systems, electrical cut-off devices and systems, vehicle alarm systems, radio systems, and electromagnetic systems. Upon receiving signal from the input devices/systems, the core system triggers a response corresponding to the alert type and desired output. Its functionality may vary based on the on the input received and the desired output.

In one embodiment, the Core System may be Stand-alone systems installed in locations such as the vehicle dashboard and other components, 1-1, 1-2, 1-3, 1-4, 1-5 and 1-6, and operates separate from other systems in the vehicle. It may be detachable, FIGS. 2, 2A, 3, and 3A or hardwired to connect to the vehicle's mechanical, electrical or electronic circuits, or wirelessly, to systems like radios/GPS, 1-2, telephones, FIG. 10, and smart watch, FIG. 6, etc. It may utilize USB connector, cigarette lighter connector and/or long-lasting (Lithium) battery pack to ensure continuous connectivity, especially in situation where the vehicle losses its power.

In a second embodiment, the Core System shall be hardwired to, or as part of the vehicle structure. This may be especially useful, if vehicle manufacturers opt to provide this system as options in late model vehicles, or it may be factory or professionally installed as add-ons to pre-existing, older model vehicles. In any of such options, the core system may be installed to work off a vehicle electrical, electronic or mechanical system, such as the brake, alarm system, lighting system (e.g. brake light, overhead light, moon/sun roof electrical system), or other accessory electrical and/or mechanical panels, or any systems that can accommodate such installations.

In a third embodiment, the input devices are hardwired into, and are part of the Core Systems. The functionality remains the same as other embodiments, i.e. when the input devices are activated; they trigger the core system to produce a signal corresponding to the emergency input selected to be transmitted or displayed on selected display unit(s).

Display/Output Units/Devices: Display systems/devices and display formats may be visual, sound, electrical, or electronic in nature. Display devices include, but not limited to, flexible panels, FIG. 5, darkened sections of vehicle windshields, combination “input-core-output” systems like the VEMAS stand-alone system, FIG. 3, cellular phones, FIG. 10, cellular phone applications (Apps), and visual/banner display panel, FIG. 4, with collapsible vinyl material/component, 4-1.

It may also include Voice, Audio devices including, but not limited to, Radios, Alarms, Horns, Sound System, fuel cut-off systems/valves, electrical cut-off/shut-off systems, remote navigation systems, and Electrical, Mechanical and Wheel/brake systems. Output format include, but not limited to: Electronic communication, such as Text messaging and Electronic mail, Telephone (voice/video) Communication, Holograms, Lighted Texts, LEDs, Strobes, Television, Laser Displays, and any other Visual Displays deemed appropriate for such messaging.

In the first embodiment: The output devices include Visual/Banner Display Panel (V/BDP), FIG. 4, or Flexible (or rigid) Polyvinyl Chloride (PVC) Panel, like FIG. 5. Both panels may (or may not) be retractable. The V/BDP, may also be made from Flexible Poly Vinyl Chloride (Flex PVC) material, like FIG. 5, or similar material, possibly rectangularly shaped, with neo magnets mounts, 4-2 and 5-2, to aid in retraction and/or to hold the devices in place. The devices could be mounted on top of vehicles in locations where they can be easily visible and displayed texts readable by drivers/passersby. The retractable Flex PVC panel embodiment will have the capability to lay flat (retract) against the roof of the vehicle and return to an upright position, upon receiving signal to display the selected preprogrammed emergency/alert type or it could retract into a column within the vehicle, and/or lay flat against the inside roof of the vehicle.

A second embodiment utilizes display devices, like LED Banner Display System (LBDS), FIG. 8, which displays LED messages. It comprises swivel component, 8-1, for rotation and positioning of the BDP, the suction cup mount, 8-2 and Banner Display Panel (BDP), 8-3, that displays LED messages. The LBDS can also utilize magnets, 4-2 and 5-2, to mount the LBCU to pre-designated surfaces, such as a rail, 5-1, or other surfaces. The device(s) may also utilize magnets components, 4-2, to mount unto metallic/magnetic surfaces, such as the vehicle roof.

The LBCU will be pre-programmed with messaging and will illuminate the LED lights to read the message based on the emergency selected. Other lighted/lighting display formats, like holographs, laser, LED display on tinted portions of front and rear windshields, can be used in these embodiments. The LBDS is connected to the LED Banner Control Unit (LBCU), FIG. 7, which is preprogrammed with, and controls, the messages displayed on the LBDS. The V/BDP, FIG. 4 and Flex PVC panel, FIG. 5 can also be used as LED/Banner Display units.

In a third embodiment, portions of a vehicle windshield shall be tinted to provide darkened background for LED, laser and holographic messaging displays, without obstructing the view of the driver.

In a fourth Embodiment, the display device may be a self-contained or standalone input-core-output device, FIGS. 3 and 3A, which will be able to perform all three functions, i.e. input, core (processor) and display functions. When used for display externally, the system should be weather-proof and detachable.

In a fifth embodiment, the display system may be installed as part of the vehicle's alarm system or a stand-alone alarm system. This system may also be remotely operated with a remote control, FIG. 2A, or manually operated to activate the alarm or Delayed Emergency Alarm System (See Delayed Emergency Alert System (DEAS below). The alarm system would also transmit preprogrammed sounds or voice/audible talking voice messaging to communicate the emergency.

In a sixth embodiment, installed Prepaid Cellular Telephone Box (PCTB) shall be installed in the vehicle, and work like a mobile cellular phone. It will either connect via aerial telephone connection, through Wi-Fi or pre-paid mobile phone services. The operator or occupant of a vehicle will be also able to utilize the PCTB for contacting preprogrammed/appropriate entities.

In a seventh embodiment, existing mobile cellular phones, FIG. 10, pre-existing location applications (Apps) or new Apps designed specifically for this invention shall be utilized. It will have the ability to send and receive preprogramed/automated emergency alert messages and phone calls. This embodiment will also function as an input and output device. Aside of regular cellular phone services these devices may send and receive signals through Bluetooth and Wi-Fi.

In an eighth embodiment, radio system may be utilized. In these embodiments, the system may transmit messages through the vehicle's radio system/components, 1-2, to feed real-time emergencies and alerts to radio stations.

### DETAILED DESCRIPTION OF THE INVENTION

Operation and workings of the system is simple. This invention operates via signal from a preferred input device(s) such as depicted in FIGS. 1, 2, 2A, 3, 3A, 6, 9, 10, 11, 12, and associated components, to core systems/processors, like FIGS. 2 and 3, and component 13-1, which may be detachable or fixed, stand-alone or hardwired, to produce the desired output. The output may be audio, voice, visual, electronic, electromagnetic, communicative, or a combination of outputs, through preferred portable or installed display devices or transmitters, like FIGS. 1, 2, 2A, 3, 3A, 4, 5, 6, 8, 10, etc., and component 13-3. All VEMAS-specific devices and systems, including input, core and output systems/devices may be fixed, or detachable and removed from the vehicle as deemed necessary.

### Input Devices and Systems

Input devices/systems may be portable or hardwired to systems; whereby through the push of buttons, as shown in FIG. 1 and its referenced components, 1-1 through 1-5, and FIGS. 6, 7, 11, and 12, or the strokes of keyboards FIGS. 2, 6, 10, and components 1-2 and 1-5, or by pulling of a lever, or depressing a pedal, the operator is able to select pre-coded/preprogrammed input which signals the core system or processor, FIG. 2, 3, and possibly component 13-2, to transmit the desired emergency message to appropriate output devices and/or receivers, such as FIG. 1 components, 1-2 and 1-5, and FIGS. 2, 3, 3A, 4, 5, 6, 8, 10, causing them to display the desired emergency messages or alerts.

Messages may be transmitted manually, electronically, via sounds and alarms, telephonically, or via pre-existing Wi-Fi or Bluetooth technology. Input devices, whether separate or embodied with the core system, shall be in areas where they shall be easily accessible to occupants of the vehicle, especially the driver and front passenger. It may be hand-held, such as, FIG. 2A, or components on the dashboard, 1-4, 1-6, components on the console, 1-3, steering wheel, 1-1, part of the vehicle (remote entry) key, FIG. 11, or somewhere on the armrest of the driver and passenger seat. Care should be taken when selecting these locations, to avoid accidental activation of system.

Portable Input Devices shall be detachable or wearable, such as cellular phones, remote control devices, FIG. 2, 2A and any other device(s) that can be worn and/or carried inside and outside of the vehicle, like smart watch, FIG. 6, tie clip, FIG. 9, telephones, FIG. 10 and headphones, FIG. 12. It may also be part of the vehicle's remote entry, FIG. 11, or alarm key, which can remotely activate the core system. The remote entry key, FIG. 11, the stand-alone VEMAS unit, FIG. 2 and Remote control, FIG. 2A have the functions of alert law enforcement or designated response teams upon press/activating the “911” panic buttons.

Hard-wired Input Devices may be part of the core system or the vehicle structure, with the buttons, lever, or pedal attached to the core system or to the vehicle. The functionality shall be the same as the remote input devices. They shall be able to activate the core system, like the remote input devices.

### The Core System (Processor)

The processor may embody one of two systems, a stand-alone system, FIG. 2, 2A and FIG. 3, 3A or a system hardwired into the vehicle structure or components, like 1-5. The embodiments of the core systems shall operate in similar manner. The main difference is the installation, whether it is stand-alone or hardwired, and its interaction with other systems in the vehicle. The systems may interact with the lighting system, electrical system, electronic system, audio system, Wi-Fi and Bluetooth, telephones, brake systems, etc. Both systems, stand-alone or hardwired shall be operated at the push of buttons, strokes of keys, pulling of levers, or depression of pedals; the input device will energize the core system to produce a preprogrammed message signal corresponding to the emergency input selected. This message could be transmitted by sound, electrically, electronically or mechanically by the core system, as display texts, audio messages, alarm sounds, audible voice, or automatic phone call or text messages, depending on the selected emergency, delivery method and preprogramming.
Core Systems may utilize cellular phone application (app), preloaded and customized for specific emergencies.
Core Systems may utilize prepaid telephone boxes installed in the car. This may be a back-up system in situations where mobile cellular phones have limited or no signals.
Core Systems may be attached to the vehicle's existing audio system, like radios, navigation system, Bluetooth, or systems, specifically designed and installed to function as a core system.
Hardwired Input, which is part of the Core Systems, such as component 13-1, shall be located with the core systems, and in areas where they shall be easily accessible to occupants of the vehicle, especially the driver and front passenger. It may be on the dashboard, console, steering wheel, or on/under the armrest of the driver's seat. Care should be taken when selecting these locations, to avoid accidental activation of VEMAS.

### Output Systems

The output system may operate separately or in combination modes. Upon receiving a signal from the core system, the output will relay a preprogrammed message to preselected recipients and/or emergency responders. Additional information on VEMAS output types will be discussed under Messages and Alerts.

Display/Output Devices:

Display/Output Devices will be one or a combination of the following:
Retractable Display Panels made from Flexible Poly Vinyl Chloride (Flex PVC) material, FIG. 5, Visual/Banner Display System, FIG. 4 or similar material, possibly rectangular, with neo magnets on its edges, as desired, to aid in retraction. This will be mounted on top of the vehicle, in a location where it can be easily visible and the texts readable by drivers/passersby. The mount component, 5-1, may be permanently installed on the vehicle or detachable. Magnets and clamps may be used to secure the mount and the display device. The retractable device could flatten (retract) against the roof of the vehicle and return to an upright position, upon actuation of preprogrammed emergency button(s) or it could retract into a column on the inside of the vehicle. In all forms, the output device, housing material and column will be weather-proofed.
Front or Rear Windshield. Portions of the windshield shall be tinted to provide darkened background for LED, laser/holographic text displays, without obstructing the view of the driver.
Alarm System may be installed as part of the vehicle's alarm system or a stand-alone alarm. This system may also be remotely operated with a remote control or manually operated to activate the alarm or Delayed Emergency Alarm System (See DEAS).
Installed Prepaid Cellular Telephone Box. This will be installed in the vehicle and work like a mobile cellular phone. It will either connect via aerial telephone connection, through Wi-Fi or pre-paid mobile phone services.
Mobile (Cellular) Phones/Mobile Phone Application (Apps) for preprogramming messages, and message recipients to receive automatic emergency alerts and phone calls. Outside of regular cellular phone service these may send and receive signal through Wi-Fi.
Radio System: The system will transmit the emergency through the vehicle's radio to a station to feed real-time to radio stations. See Radio Alert below.

### Messages and Alerts

LED/Strobe Texts Alert: Display lights (could be Hologram, Led or Strobes) will be located on the sides, back, or both, of vehicles where it can be easily seen and read. The holograms could be a picture of the emergency type, such as a picture of a person that is choking, the Led or strobe text (texts) will be displayed in letters, spelling out the type of emergency and help required; this will be conspicuously displayed to notify other drivers and passersby to either provide or call for help. The button/lever will be pre-coded with different/common emergency situations such that, if the driver pushes a button, pulls a lever or depresses a pedal, the pre-coded message will be displayed, clearly spelling out the type of emergency and possible help needed.

For instance, if a driver or passenger(s) is having a stroke in the vehicle, the occupant of the vehicle should be able to activate the: “MEDICAL EMERGENCY, Please Call 911” or for vehicle/mechanical failure; “ROADSIDE ASSIST” or “VEHICLE EMERGENCY,” display lights. This way any responder can clearly see and read the emergency.
Font and Alignment: The size of the LED/Strobe letter may be 0.5 inches or larger, the font, font color and text alignment, shall be selected according to readability and individual/manufacturer' preference.
Alarm/Sound Alert: Alarm will sound upon activation, to alert passersby and emergency responders of the emergency or impending danger. Pushing the emergency button on the entry remote key, a portable/wearable device, or VEMAS system, inside of the vehicle, shall activate alarm. Alarm voice may be male or female and very distinct. It shall read out the emergency. Alarm may be a typical alarm sound or ring tone.
Delayed Emergency Alarm System (DEAS) may be installed to ensure security of the operator, especially in hostile situations like carjacking. (See DEAS.)
Cellular Phone (CP)—Text Messaging/App. Cellular Phones (CP) will be pre-coded and linked to the VEMAS system through Wi-Fi. Once activated, the CP will automatically send text messages and emails to pre-designated recipients, including law enforcement officials if desired, at the push of a button and/or lever. The message will be pre-coded for different situations, e.g., “I'm having a Diabetic Episode, please help or call Police.” The CP system can also incorporate video and location/tracking devices to show the person/emergency, in real-time situation. This will also help responders to see whether the situation is a hoax or dangerous (i.e., if an intruder or impostor, is trying to use this technology to hijack or implement a dangerous outcome).

VEMAS App may be downloaded to the cellular phone and messages/recipients customized, as needed.
Radio Alert: Radio Alerts may be applied in several ways, to include, but not limited to, connecting to radio stations and televisions, especially in cases of floods, fires, national emergencies, terrorists' attacks, active shooters, and other alerts and warnings that require media attention. This system will provide feeds to radio stations. It may also incorporate video messages, through embedded camera to capture the situation and feed real-time information of the emergency.

Radio Alert system may operate via the radio system through Bluetooth or Wi-Fi upon actuation of the buttons and levers as described in cellular phone system above.
Holograms/Laser System (H/L): Pushing the input button, lever or pedal, as described above, will energize the H/L system to display emergency message through optical hologram elements that directs light in a way that holographic letters are projected on the windshield (front or rear) of the vehicle.
Holograms/Laser: Systems that use holograms or laser for display will be projected on the rear or front windshield. Note, that this display may be adversely affected by time of day. Tinting of the display area may resolve the lighting problem.
Fire Sensors: These may be installed in case of fire emergency to relay such messaging through the display devices/systems.

### Delay Emergency Alert System (DEAS).

In situations where a car is being hijacked, or during highway robberies, drivers will have the option of pressing a “delayed” display button and/or a remote-controlled button that will self-activate the vehicle's alarm/alert system after a specified time has elapsed. The “911” panic function will also be activated. This delay button can only be switched off with pre-programmed passcodes or by predesignated emergency response units or authorized system control entities.

To accommodate accidental trigger, the alarm will issue a warning message such as, “VEMAS Energized, Deactivate System Now.” This message will run for a few seconds to a minute, or a predetermined time period, to allow the vehicle operator time to enter the passcode, if the vehicle is stolen, or the passcode is unavailable or incorrect, the alarm will sound after the specified time has elapsed. To prevent bypassing the code, the warning will also sound or flash on the remote-control unit, giving the legitimate operator the opportunity to press a code that will prevent unauthorized persons from bypassing the codes. LED/Strobes message may also be displayed along with sounding the alarm. Messages like, “This Vehicle is Stolen, Call Police,” may be displayed on the Flex PVC or via holographic display, or any other output device, described above; this will be accompanied by screaming voice from the vehicle audio, alarm or sound system, that will relay messages as above, like: “I have been stolen, call 9-11”, such that attention will be drawn to the vehicle and passersby's will be inclined to report/call the police. This also, will make it impossible for the thief or intruder to keep driving the vehicle, while it is screaming, and/or displaying “thief” or similar messages, or while the car is lit up with a kaleidoscope of lights all around it, similar to a fire truck.

Kill switches, as addition, may be installed to automatically disable the vehicle once the alarm is activated. When used properly, this device may be advanced to where it can be remotely controlled and applied in extreme situations like in “Amber Alerts” situations, lost persons/pets tracking, etc. and for use aside from vehicles.

### DESCRIPTION OF THE PREFERRED EMBODIMENT

Vehicle Emergency Alert System (VEMAS), includes dashboard display light actuation buttons or display light activation/actuation levers, LED display lights and electrical wiring that connects from the dashboard (and/or the location of the activation buttons and levers) of the vehicle to the chosen location of the lighting display. The light shall be colored/color-coded based on the type of emergency, e.g., blue for medical emergency, red for fire or robberies, etc., and will have the ability to flash or scroll continuously, or remain steady for a preprogrammed duration, or until it is turned off. VEMAS may be connected to the flashing light switch/system already in the vehicle, brake switch, overhead lighting system, or accessory.

### Display Locations:

The strobe lights texts shall be placed in conspicuous locations where anyone including law enforcement, emergency medical response teams (EMT) and other drivers or pedestrians can easily and clearly see the displayed message.

Examples of display locations include, but not limited to:
Display Locations (Hood): Display panels can be located on vehicle' hoods or at the back in cases of motorcycles and like vehicles.
Display Locations (Roof): Display panels/devices can be mounted on the roof of a vehicle. This could be a permanent mount, detachable mount or only the mount can be permanently installed, and the output/display device would be attached/removed from the mount as needed.

Mode of Installation:

VEMAS may be hardwired into the vehicle's alarm, sound, electrical, and/or electronic systems, etc. It may also be stand-alone systems, or removable systems that can be installed as an external system.
Hardwired: This may be a preferred method for newer model vehicles, where the manufacturers will provide this system as options. The system may be integrated into the vehicle pre-existing systems, like GPS systems, OnStar, etc. It could be connected to the electrical system, depending on the exact location, it may be connected to the front, rear, roof, electrical system or to electronic, sound or alarm system. There are limitless connection/installation options for VEMAS.
Stand-alone: These systems can be purchased separate from the vehicle, possible option for older/pre-existing vehicles. Installation may be tied to the vehicle's accessory panel, rear or side lights wiring, depending on the preferred location of the display. As with the hard-wired system, there is flexibility to the installation/location choices for VEMAS.

Power Supply:

VEMAS could be electric, solar and/or battery powered, to ensure continuous power supply. Other mode of powering and operation can be used, as deemed necessary or appropriate. The battery option shall be 12 Volts AC or Lithium battery. Cellular phones (input/output system) will utilize the cellular phones battery pack as designed, once the app is downloaded to the Cellular phone(s) whether or not the vehicle has its own power, cellular phones should be able to operate on its own power. The display panel can be connected to either a 12 Volts AC battery or the vehicle battery as back up. Solar panels can also be used to provide power when installed. VEMAS will also be adapted for USB and similar charging ports and outlets, such that the vehicle cigarette lighter ports can be used to charge the device.

Other Applications:

This technology can be applied to other vehicles, such as:
Airplanes: In airplanes, specific buttons shall be strategically located. For instance, in a terrorist/hostage situation, the button can be located close to the bottom edge of the pilot/co-pilot seats where he/she can push it without drawing any attention. Other buttons can be located at the flight attendants' station and kitchen area.
Sailing Vessels and Ships.
Motorcycles, Bicycles, Scooters: The button shall be close enough to the handle, such that the rider can push it without moving his/her hand too far from the grip. The light shall display at the back of the vehicle.
Other—Non-Vehicular Applications, such as:
   Detachable/Potable VEMAS System and the cellular phone app can be worn, carried, and used by anyone, including hikers, campers, and kids to send messages in emergencies and/or if someone is lost/missing. All VEMAS system will be able to pull the location, report the type of emergency and help needed, messages will be in the form of visual, audio message, cellular phone text message or phone call and visual text message display, etc.
   Pets and other animals can have VEMAS sensor chips, when ethically and legally allowable.

1. A vehicle emergency alert system for communicating, alerting and displaying of emergency/impending emergency events, also capable of providing safe disabling mechanism in response to an event. Wherein, the system comprises: activation mechanisms, processors, transmitters and memory devices to facilitate selecting applicable emergency types, communication type and media type for the alert and type of display desired; it provides location of event, provides selection of entities to be contacted, provides pre-programmed messages to be communicated, displays the emergency alerts and the type of assistance required based on the emergency type and preprogrammed contactable entities and communication medium selected. System mechanisms Include but not limited to:
Actuator or Activation—levers, buttons, voice, wrist worn devices, hair/tie pins, hand clap, etc.
Core System—the processor.
Communication System, processors, transmitter and display
Display forms relay messages (such as: lighting, holograms, cellphone, sound systems)
Disabling System

2. The alert method of claim 1, the actuation (or activation) mechanism, being further configured as assorted types input devices, such as levers, buttons, etc., to accommodate the medical condition, personal ability and emergency of the operator, which the operator wishes to relay.

3. The alert method of claim 1, the actuation (or activation) mechanism, being further configured as digital, manual, mechanical, Wi-Fi, or voice-activated devices. This can also be automatically activated, or sensor activated, such as the seizures of epileptic patients or extreme (life threatening) body heat or cold can either activate the system.

4. The alert method of claim 1, the actuation (or activation) mechanism, being further configured to be within the immediate reach of the operator, such that the operator will be able to activate the system without extraneous effort. For example: a trigger button on the steering wheel, such that if a heart-attack or stroke patient slumps and his/her head hits the steering wheel and pushes the button, the system will be activated.

5. The alert method of claim 1, the actuation (or activation) mechanism, being further configured to be voice activated if the operator is unable to digitally or manually operate the device.

6. The alert method of claim 1, the actuation (or activation) mechanism, being further configured to relay emergency input to the core “emergency alert” system.

7. A vehicle emergency alert system for communicating, alerting and displaying of emergency/impending emergency events and in certain cases, providing safe disabling mechanism in response to an event. Wherein, the system comprises: a core system of processors, memory devices, switches, relays, transmitters, etc., that can be triggered by actuation/activation mechanisms to facilitate sorting and selecting of appropriate preprogrammed emergency alert types, mode of communication, and preferred display media; provides location of event, provides selection of entities to be contacted, select the pre-programmed emergency and alert messages to be displayed or communicated.

8. The alert system of claim 7, the core system, which could be a stand-alone, detachable or hardwired system, being further configured to be within the immediate reach of the operator, wherein the actuation (input) device may be built into the core system. Wi-Fi devices, voice activation systems, etc. may be used in this claim, as well as VEMAS systems that are built into radios, GPS systems, alarm systems or systems like OnStar, etc., can also be used in this claim and other claims.

9. The alert system of claim 7, the core system, stand-alone, detachable or hardwired systems, being further configured as a sorting, selecting, and transmitting device to fit the medical condition, personal ability, and emergency of the operator. The system upon activation sorts, identify and selects the emergency type.

10. The alert system of claim 7, the core system, stand-alone, detachable, or hardwired systems, being further configured to identify the type of emergency based on input signal received from the actuation device; to sort through a database of preprogrammed or previously entered information in order to select the type of alert to communicate and the most appropriate display or communication media through which the massage will be relayed and/or displayed.

11. The alert system of claim 7, the core system, stand-alone, detachable or hardwired systems, being further configured to identify the type of emergency based on input signal received from the actuation device; to sort through a database of preprogrammed or previously entered information in order to select the entities to contact, if necessary, provide location of event, and in some cases, disable the vehicle.

12. The alert system of claim 7, the core system, stand-alone, detachable or hardwired systems, being further configured to relay the need for emergency through the selected display media and/or transmit to other non-visual media like mobile phones, law enforcement entities, and/or sound an alarm or utilize/VEHICLE transmit through a speaking-voice type alarm.

13. A vehicle emergency alert system for communicating, alerting and displaying of emergency/impending emergency events and in certain cases, providing safe disabling mechanism in response to an event. Wherein, the system comprises: various display and communication media, activated by input from the core system to facilitate sorting and selecting the appropriate display and communication mode.

14. The alert system of claim 13, the display mechanism, being further configured to cause a sensor or group of sensors in the alert system to determine and process and send/transmit the appropriate alert type and communication media for the event to preprogrammed contactable entities.

15. The alert system of claim 13, the display mechanism, being further configured to conspicuously display the alert in readable visual lighting, such as LED, holograms, visible to other drivers, passersby, pre-selected recipients and emergency responders.

16. The alert system of claim 13, the display mechanism, being further configured to clearly sound the alert, such as alarms, sound systems, human-voice, and speakers, audible to other drivers, passersby, pre-selected recipients and emergency responders.

17. The alert system of claim 13, the display mechanism, being further configured to conspicuously display the alert in readable visual and audio tones, such as cellular phone message formats, ring tones, etc., to pre-selected recipients and emergency responders.

18. A vehicle emergency alert system for communicating, alerting and displaying of emergency/impending emergency events and providing safe disabling mechanism in response to an event. Wherein, the system comprises: actuator (or activation), communication media and disabling mechanism, activated by input from the core system when triggered by the actuator, to facilitate delayed disabling of the vehicle, selecting appropriate communication mechanism (audio/visual) and time lapse before disabling of vehicle.

19. The alert system of claim 18, the disabling mechanism, being further configured as transmitting and disabling device to facilitate the disabling process after delaying for a predetermined time set by the operator.

20. The alert system of claim 18, the disabling mechanism, being further configured as a transmitting device to sound (may be delayed) audible alarm upon actuation by the operator. Unlike other vehicle shut-off systems, this may mostly be a preprogrammed human voice speaking the emergency. For instance, if a vehicle is carjacked, the pre-programmed human voice, will scream words like: “Help, I have been stolen.” Or “Thief, Call 9-11.”

21. The alert system of claim 18, the disabling mechanism, being further configured to display (may/may not be delayed) visual messages through preselected display mechanisms to alert other drivers, passersby, pre-selected recipients and emergency responders of the event. This will be visual display of similar words as in claim #20, like: “Help, I have been stolen.” Or “Thief, Call 9-11.”

22. The alert system of claim 18, the disabling mechanism, being further configured to facilitate delayed disabling of the vehicle and impede drivability of the vehicle via a disabling device pre-installed in the vehicle. This will operate like existing vehicle shut-off devices, as an addition to VEMAS functions.

23. The alert system of claim 18, the disabling mechanism, being further configured to be manually or remotely operated to facilitate delayed disabling of the vehicle and impede drivability of the vehicle. For instance, when a vehicle is stolen, the operator can wait a pre-determined time period and push a button or remote control to trigger the vehicle cut-off as well as sound the voice-alarm. The operator will not have to rely on other entities to trigger shutting off the vehicle and if the manual shut-off setting installed in the vehicle is not set, this will be a guaranteed method of triggering the vehicle shut off.

24. The alert system of claim 18, the disabling mechanism, being further configured to facilitate delayed disabling of the vehicle and impede drivability of the vehicle via voice or manual activation of a mobile disabling device carried or worn on the person initiating the disabling activity.

25. The alert system of claim 18, the disabling mechanism, being further configured to facilitate delayed disabling of the vehicle and impede drivability of the vehicle via manual activation of the disabling device installed within or outside of the vehicle, to initiate the delay disabling activity.
